(19) United States
(12) Patent Application Publication
(10) Pub. No.: US 2026/0295526 A1
(43) Pub. Date: Oct. 1, 2026

(54) STRUCTURAL BODY AND DESIGN METHOD THEREFOR, AND LIQUID DROPLET ATOMIZATION SYSTEM INCLUDING STRUCTURAL BODY

(71) Applicant: Tokai University Educational System, Tokyo (JP)

(72) Inventors: Masayuki Ochiai, Hiratsuka-shi (JP); Naoki Sugiyama, Hiratsuka-shi (JP); Asuka Kikuchi, Hiratsuka-shi (JP); Hiroki Onoue, Hiratsuka-shi (JP); Tetsuo Nohara, Hiratsuka-shi (JP)

(21) Appl. No.: 19/479,316

(22) PCT Filed: Apr. 26, 2024
(86) PCT No.: PCT/JP2024/016547

§ 371 Date: Oct. 27, 2025

(30) Foreign Application Priority Data
Apr. 28, 2023 (JP) 2023-075153

(51) Int. Cl. B01D 53/94; B05B 1/24

(52) U.S. Cl. CPC B01D 53/9431; B05B 1/24; B01D 2251/2067; B01D 2257/404; B01D 2258/01

(57) ABSTRACT

A structural body according to the present invention is a structural body which is allowed to collide with a liquid droplet, where the structural body includes a base part capable of having a temperature equal to or higher than a vaporization temperature of the liquid droplet, one or more first recessed parts provided on a surface of the base part, and a plurality of second recessed parts provided on an inner wall surface of at least one of the first recessed parts.

### TECHNICAL FIELD

The present invention relates to a structural body and a design method therefor, and a liquid droplet atomization system including a structural body.

Priority is claimed on Japanese Patent Application No. 2023-075153, filed Apr. 28, 2023, the content of which is incorporated herein by reference.

### BACKGROUND ART

As a liquid droplet atomization technology, a technology that uses a shape of an injector of a spray device, a spray pressure, an air flow, a centrifugal force, a vibration, a sound wave, static electricity, and heat is known. However, these technologies are related to a configuration on a side where liquid droplets are sprayed, and require a large-scale system configuration or special energy required for atomization. In addition, in a case where the above-described technologies are used, the electric power and cost required for energy supply are problematic.

As a liquid droplet atomization technology, there is a technology (Patent Document 1) in which a configuration on a side (a receiver side of liquid droplets) where liquid droplets are sprayed is improved; however, in a case where this technology is used, an environment temperature at which liquid droplets undergo atomization needs to be a very high temperature at which a Leidenfrost phenomenon occurs. Examples of such a high temperature environment include an environment such as a vicinity of a diesel engine as described in Patent Document 1. The exhaust gas generated from the diesel engine contains a harmful nitrogen oxide (NOx). The liquid droplet atomization technology of Patent Document 1 is suitable for the use application of carrying out this purification.

However, examples of fields in which the other liquid droplet atomization technologies can be used include fields such as chemistry, medicine, pharmaceuticals, and cosmetics. In these fields, there are few use applications in which liquid droplets undergo atomization at such a high temperature at which the Leidenfrost phenomenon occurs, and thus there are few opportunities to utilize the liquid droplet atomization technology of Patent Document 1. Therefore, even in a temperature range before the Leidenfrost phenomenon occurs, there is a demand for a technology for atomizing a liquid droplet depending on the configuration of the receiver side of the liquid droplet.

### CITATION LIST

### Patent Document

Patent Document 1: Japanese Unexamined Patent Application, First Publication No. 2021-133321

### SUMMARY OF INVENTION

### Technical Problem

The present invention has been made in consideration of the above circumstances, and an object of the present invention is to provide a structural body and a design method therefor, which is capable of carrying out the atomization of liquid droplets in a wide temperature range and capable of carrying out the atomization of liquid droplets with low energy consumption without using a large-scale system configuration, as well as a liquid droplet atomization system including a structural body.

### Solution to Problem

In order to solve the above-described problem, the present invention employs the following means.

(1) A structural body according to one aspect of the present invention is a structural body which is allowed to collide with a liquid droplet, the structural body including: a base part that has a temperature equal to or higher than a vaporization temperature of the liquid droplet; one or more first recessed parts provided on a surface of the base part; and a plurality of second recessed parts provided on an inner wall surface of at least one of the first recessed parts.

(2) In the structural body according to (1), it is preferable that a hole diameter of the first recessed part is larger than a particle diameter of the liquid droplet before the collision, a hole diameter of the second recessed part is smaller than the particle diameter of the liquid droplet before the collision, a total of a volume of the first recessed part and a volume of the second recessed part is larger than a volume of the liquid droplet before the collision, and at least a part of a space in the first recessed part is filled with the liquid droplet after the collision.

(3) In the structural body according to (1) or (2), the temperature equal to or higher than the vaporization temperature may be a first temperature at which a vaporization phenomenon or a boiling phenomenon of the liquid droplet occurs and which is lower than a temperature at which a Leidenfrost phenomenon occurs.

(4) In the structural body according to any one of (1) to (3), the temperature equal to or higher than the vaporization temperature may be a second temperature at which a vaporization phenomenon, a boiling phenomenon, and a Leidenfrost phenomenon of the liquid droplet occur in a mixed manner.

(5) A design method for a structural body according to one aspect of the present invention is a design method for the structural body according to any one of (1) to (4), the design method including determining a configuration of the first recessed part and the second recessed part such that, in a state in which the liquid droplet collides with the structural body and enters the first recessed part and the second recessed part, a surface tension at the temperature equal to or higher than the vaporization temperature of the liquid droplet is smaller than an explosion energy of air bubbles generated in the liquid droplet, and the air bubbles include a first air bubble generated by a heat flux transferred from an inner wall surface of the first recessed part and an inner wall surface of the second recessed part to the liquid droplet in contact with the first recessed part and the second recessed part, and a second air bubble generated in a case where air trapped between the collided liquid droplet and the inner wall surface of the second recessed part is incorporated into the liquid droplet.

(6) A design method for a structural body according to one aspect of the present invention is a design method for the structural body according to any one of (1) to (4), the design method including: determining the base part, hole diameters, depths, and the number of the first recessed parts, and hole diameters, depths, and the number of the second recessed parts based on a Weber number of the liquid droplets and a temperature of an installation location for the structural body.

(7) A liquid droplet atomization system according to one aspect of the present invention includes a structural body according to any one of (1) or (4).

### Advantageous Effects of Invention

According to the present invention, it is possible to provide a structural body and a design method therefor, which is capable of carrying out the atomization of liquid droplets in a wide temperature range and capable of carrying out the atomization of liquid droplets with low energy consumption without using a large-scale system configuration, as well as a liquid droplet atomization system including a structural body.

### BRIEF DESCRIPTION OF DRAWINGS

FIG. 1A is a plan view of a structural body according to a first embodiment of the present invention.

FIG. 1B is a cross-sectional view of the structural body according to the first embodiment of the present invention.

FIG. 2A is a cross-sectional view of the structural body according to the same embodiment, where FIG. 2A is a view showing a collision process of a liquid droplet.

FIG. 2B is a cross-sectional view of the structural body according to the same embodiment, where FIG. 2B is a view showing a collision process of a liquid droplet.

FIG. 3A is a cross-sectional view of the structural body according to the same embodiment, where FIG. 3A is a view showing a collision process of a liquid droplet.

FIG. 3B is a cross-sectional view of the structural body according to the same embodiment, where FIG. 3B is a view showing a collision process of a liquid droplet.

FIG. 4A is a plan view for describing a mechanism for formation of fine particles of a liquid droplet, in which the structural body according to the embodiment is used.

FIG. 4B is a plan view for describing a mechanism for formation of fine particles of a liquid droplet, in which the structural body according to the embodiment is used.

FIG. 5 is a perspective view of a structural body according to a second embodiment of the present invention.

FIG. 6 is a plan view of a structural body according to a third embodiment of the present invention.

FIG. 7 is a cross-sectional view of an exhaust gas purification system including the structural body according to any of the above-described embodiments.

FIG. 8A is a photomicrographic image of the surface side of a structural body according to Example 1.

FIG. 8B is a photomicrographic image obtained by enlarging a part of the structural body of FIG. 8A.

FIG. 8C is a photomicrographic image obtained by enlarging cross sections of a first recessed part and a second recessed part included in the structural body shown in FIG. 8B.

FIG. 9A is a graph showing a relationship between a collision velocity of a liquid droplet with a structural body of Comparative Example 1 and a particle diameter of the liquid droplet after the collision.

FIG. 9B is a graph showing a relationship between a collision velocity of a liquid droplet with a structural body of Comparative Example 2 and a particle diameter of the liquid droplet after the collision.

FIG. 9C is a graph showing a relationship between a collision velocity of a liquid droplet with a structural body of Example 1 and a particle diameter of the liquid droplet after the collision.

FIG. 10A is a graph showing a relationship between a collision velocity of a liquid droplet with a structural body of Comparative Example 4 and a particle diameter of the liquid droplet after the collision.

FIG. 10B is a graph showing a relationship between a collision velocity of a liquid droplet with a structural body of Example 2 and a particle diameter of the liquid droplet after the collision.

FIG. 11 is an image obtained by imaging the behavior of a liquid droplet collided with the surface of the structural body of Comparative Example 4.

FIG. 12 is an image obtained by imaging the behavior of a liquid droplet collided with the surface of the structural body of Example 2.

FIG. 13 is a graph showing a relationship between a particle diameter of a liquid droplet and a vaporization time of the liquid droplet before the collision.

FIG. 14 is a graph obtained by enlarging a part of the graph of FIG. 12.

### DESCRIPTION OF EMBODIMENTS

Hereinafter, a structural body according to an embodiment to which the present invention is applied and a liquid droplet atomization system including the structural body will be described in detail with reference to the drawings. It is noted that in the drawings used in the following description, in order to make features easier to understand, a characteristic portion will be enlarged for convenience in some cases, and a dimensional ratio or the like of each configurational component is not necessarily the same as the actual one. In addition, materials, dimensions, and the like mentioned in the following description are examples, and the present invention is not limited thereto and can be implemented with appropriate modifications within the scope which is not departing from the gist of the present invention.

### First Embodiment

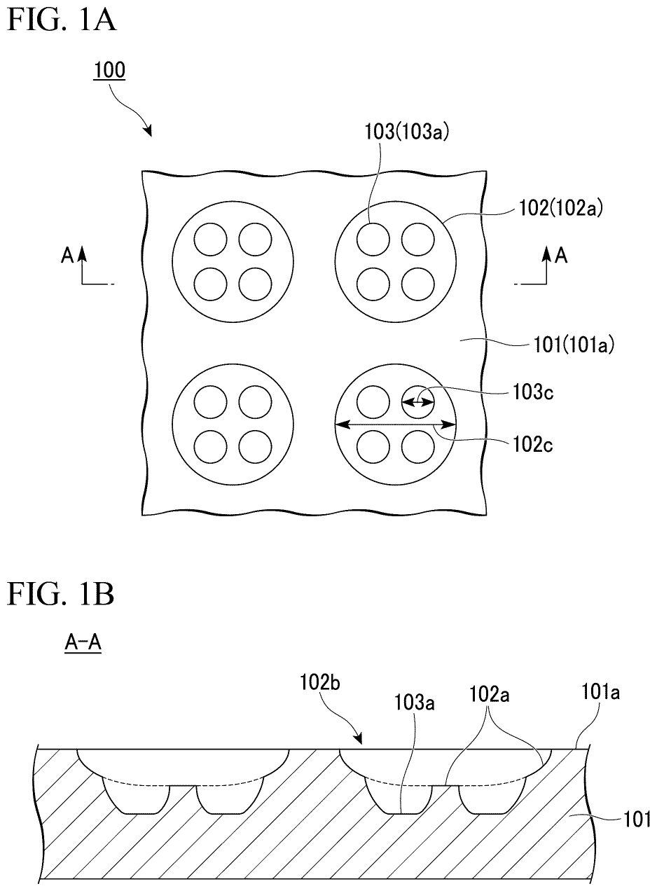

FIG. 1A is a plan view of a structural body 100 according to a first embodiment of the present invention. FIG. 1B is a cross-sectional view of the structural body 100 of FIG. 1A in a case where the structural body 100 is cut along a plane including the line A-A. The structural body 100 is a structural body which is allowed to collide with a liquid droplet, where the structural body 100 has a function of atomizing the liquid droplet that has collided on the surface thereof. The structural body 100 mainly includes a base part 101 capable of having a temperature equal to or higher than a vaporization temperature of a liquid droplet that is allowed to collide; one or more first recessed parts 102 of the surface of the base part 101, where the one or more first recessed parts 102 are provided on the surface (wall surface) 101a on which the liquid droplet collides; and a plurality of second recessed parts 103 provided on an inner wall surface (preferably a bottom surface) of at least one of the first recessed part 102. A portion of the surface 101a excluding the first recessed part 102 is often flat or unprocessed; however, it is not limited thereto.

The structural body 100 may constitute a part of another structure (for example, a side wall of a pipe) or may be installed on a surface of another structure. The shape and size of the base part 101 of the structural body are designed according to various use applications. In a case where the structural body 100 is installed on a surface of another structure, the base part 101 preferably has a plate shape from the viewpoint of stability. For example, in a case where a surface on which another structure is to be installed is not flat, the shape may be a shape that fits to the shape of the surface on which another structure is to be installed. In addition, the base part 101 may be deformable in accordance with the shape of the surface on which another structure is to be installed.

The base part 101 of the structural body is made of a material suitable for various use applications. In a case where the structural body 100 constitutes a part of a side wall of a pipe as described later, ferrite-based or austenite-based stainless steel such as SUH409L, SUS430, SUS430J1L, SUS429, SUS444, SUSXM15J1, SUS304, SUSX15J1, SUS436J1L, SUH409L-A1, or SUS436, or the like can be used as a material of the base part 101. In addition, in a case where the structural body 100 is a structural body that promotes the dispersion and vaporization of liquid droplets due to collision with a part of a mixer or another collision, ferrite-based or austenite-based stainless steel such as SUH409L, SUS430, SUS430J1L, SUS429, SUS444, SUSXM15J1, SUS304, SUSX15J1, SUS436J1L, SUH409L-A1, or SUS436, or a material such as a composite material of aluminum, copper, ceramics, and plastic can be used as a material of the base part 101.

The structural body 100 can be used under various use conditions, and can be used in a temperature range equal to or higher than the vaporization temperature of the liquid droplet. Here, the temperature equal to or higher than the vaporization temperature means either a first temperature at which a vaporization phenomenon or a boiling phenomenon of the liquid droplet occurs and which is lower than a temperature at which a Leidenfrost phenomenon occurs, or a second temperature at which a vaporization phenomenon, a boiling phenomenon, and a Leidenfrost phenomenon of the liquid droplet occur in a mixed manner. Although the first temperature and the second temperature are different from each other according to the liquid droplet, for example, in a case where the liquid droplet is water, the first temperature is in the vicinity of 100° C. to the vicinity of 150° C. The second temperature is in the vicinity of 150° C. to the vicinity of 200° C. In this way, the first temperature and the second temperature are determined by the physical property value of the solution constituting the liquid droplet. The structural body 100 has heat resistance at least in a temperature range equal to or higher than the vaporization temperature of the liquid droplet. It is noted that the temperature at which the Leidenfrost phenomenon occurs is a temperature at which a vapor film is formed on the surface to cause a heat insulation phenomenon to occur, and it is, for example, in the vicinity of 200° C. to the vicinity of 300° C. in a case where the liquid droplet is water.

One or more of the first recessed parts 102 are provided on the surface 101a of the structural body, and have a recessed structure that is recessed inward from the surface 101a. In the present embodiment, the recessed structure of the first recessed part 102 means a portion (a portion above the broken line in FIG. 1B) excluding the recessed structure of the second recessed part 103 among the recessed structures that are recessed inward from the surface 101a. The shape of the inner space of the first recessed part 102 is not particularly limited; however, it may be, for example, a substantially columnar shape. From the viewpoint of ease of manufacturing, the shape may be a shape (substantially conical shape, substantially hemispherical shape, or the like) that becomes narrower as it approaches the bottom surface.

One or a plurality of second recessed parts 103 are provided on at least one inner wall surface 102a of the first recessed part, and have a recessed structure that is recessed inward from the inner wall surface 102a (preferably the bottom surface). The shape of the inner space of the second recessed part 103 is not particularly limited; however, it may be, for example, a substantially columnar shape. From the viewpoint of ease of manufacturing, the shape may be a shape (substantially conical shape, substantially hemispherical shape, or the like) that becomes narrower as it approaches the bottom surface.

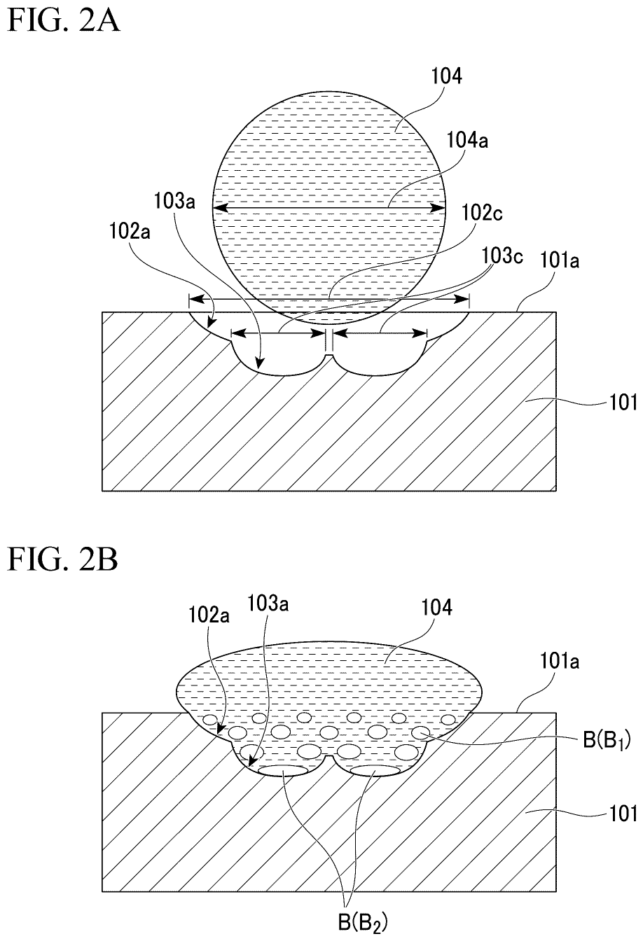

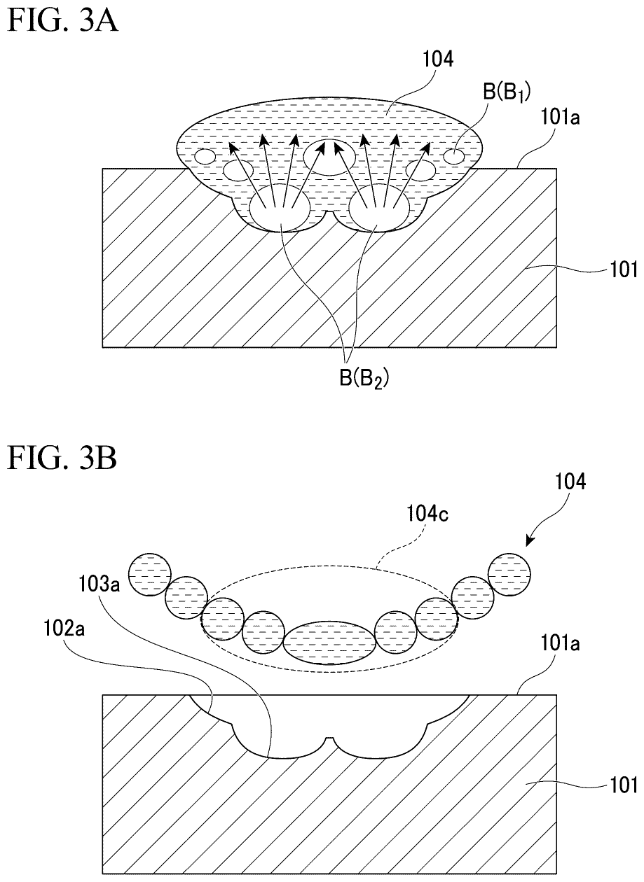

FIG. 2A, FIG. 2B, FIG. 3A, and FIG. 3B are cross-sectional views of the structural body 100 and show states before and after a liquid droplet 104 collides with the surface 101a of the base part. FIG. 2A shows a state immediately before the liquid droplet 104 collides at a position where the first recessed part 102 is provided, in the surface 101a of the base part. In a case where the particle diameter 104a of the liquid droplet 104 before the collision is larger than the hole diameter (inner diameter) 102c of the first recessed part 102, the air present in the first recessed part 102 and the second recessed part 103 cannot escape, and a layer of air is formed, which makes it difficult for a part of the collided liquid droplet 104 to enter the first recessed part 102 and the second recessed part 103. Therefore, it is preferable that the hole diameter (the inner diameter, the minimum diameter) 102c of the opening surface 102b of the first recessed part is larger than the particle diameter 104a of the liquid droplet 104 before the collision. Specifically, in a case of being seen in a plan view from a direction orthogonal to the surface 101a of the base part, the hole diameter 102c of the first recessed part is larger than the particle diameter 104a of the liquid droplet 104 before the collision, preferably 110% or more and 180% or less of the particle diameter 104a of the liquid droplet before the collision, and more preferably 120% or more and 160% or less of the particle diameter 104a of the liquid droplet before the collision. For example, in a case where the particle diameter of the liquid droplet 104 is 60 to 70 μm, the hole diameter 102c of the opening surface 102b of the first recessed part is preferably 90 μm. It is noted that the hole diameter (inner diameter, minimum diameter) 103c of the opening surface of the second recessed part is preferably smaller than the particle diameter 104a of the liquid droplet 104 before the collision. Although an exemplary example in a case of a circular shape is shown here for the shape of the hole (opening surface) of the first recessed part 102 and the hole (opening surface) of the second recessed part 103 in a case of being seen in the same plan view, the shape is not particularly limited and may be, for example, an elliptical shape, a rectangular shape, a polygonal shape, or a shape similar to these shapes.

As the area (or contact area) of the portion of the liquid droplet 104, where the portion is close to the inner wall surface 102a of the first recessed part and the inner wall surface 103a of the second recessed part, increases, the liquid droplet 104 can absorb a large amount of heat of the structural body 100. Therefore, the larger the hole diameter (inner diameter) 102c of the first recessed part 102 is in a range in which the liquid droplet 104 after the collision can close the opening surface 102b of the first recessed part, the more preferable it is. However, the present invention is not limited thereto, and the atomization described below can be carried out even in a case where the liquid droplet is small to an extent that the liquid droplet 104 after the collision cannot close the opening portion 102b of the first recessed part, as long as at least a part of the first recessed part, for example, a part in the depth direction can be filled with the liquid droplet to some extent. It is preferable that the total of the volume of the first recessed part 102 and the volume of the second recessed part 103 is larger than the volume of the liquid droplet 104 before the collision. It is preferable that at least a part of the space in the first recessed part 102 is filled with the liquid droplet 104 after the collision.

For the liquid droplet 104, FIG. 2B and FIG. 3A show in order states immediately after the liquid droplet 104 has collided with the inner wall surface 102a of the first recessed part and the inner wall surface 103a of the second recessed part.

As shown in FIG. 2B, a part of the collided liquid droplet 104 collides with a protruding part formed by the plurality of second recessed parts being arranged, thereby entering the first recessed part 102 and the second recessed part 103 while the surface is damaged. In this case, two kinds of air bubbles (a first air bubble B₁ and a second air bubble B₂) are generated in the liquid droplet 104. The first air bubble B₁ is generated by a heat flux transferred from the inner wall surface 102a of the first recessed part and the inner wall surface 103a of the second recessed part in the high temperature state to the liquid droplet 104 in contact with the inner wall surface 102a of the first recessed part and the inner wall surface 103a of the second recessed part. The second air bubble B₂ is generated by the air trapped between the collided liquid droplet 104 and the inner wall surface 103a of the second recessed part being incorporated into the liquid droplet 104.

As shown in FIG. 3A, the second air bubble B₂ grows by incorporating the surrounding first air bubbles B₁ as a boiling nucleus, and is exploded in a case where the size of the second air bubble B₂ reaches a predetermined size. Since the second air bubble B₂ grows by sequentially incorporating the first air bubble B₁ present on the upper side (the surface 101a side of the base part) of the second recessed part 103 with the bottom part of the second recessed part 103 as a starting point, the growth direction of the second air bubble B₂ is mainly upward.

The grown second air bubble B₂ is exploded in a case where the size of the second air bubble B₂ reaches a predetermined size. Since the energy of this explosion exceeds the surface tension of the liquid droplet 104, the liquid droplet 104 is deformed in a beaded shape as shown in FIG. 3B and then is atomized. The liquid droplet 104 described above collides with a protruding part formed by the plurality of second recessed parts being arranged, and thus the surface of the liquid droplet 104 is damaged. Therefore, the liquid droplet 104 is in a state where it can be easily atomized by the explosion energy of the second air bubble B₂. Since the second air bubble B₂ is exploded along the growth direction thereof, the explosion energy can be applied to the central part of the liquid droplet 104 located on the upper side, and the entire liquid droplet including the central part 104c can be separated and atomized substantially uniformly.

In a case where the liquid droplet 104 has collided, in order to trap air serving as a boiling nucleus between the liquid droplet 104 and the inner wall surface 103a of the second recessed part, the volume of the second recessed part 103 per one second recessed part 103 is preferably 2% or more and 8% or less of the volume of the first recessed part 102 in which the second recessed part 103 is provided. For example, in a case where the particle diameter of the liquid droplet 104 is 60 to 70 μm, the volume of the second recessed part 103 can be set to 4.2×10⁻⁷ mm³ or more and 1.7×10⁻⁶ mm³ or less. In addition, from the viewpoint of maintaining a high compression ratio of air in the first recessed part 102, the total volume of the second recessed parts 103 provided on the inner wall surface 102a of the first recessed part 102 per one first recessed part 102 is preferably 8% or more and 32% or less of the volume of the first recessed part 102 per one first recessed part 102. It is noted that in a case of being seen in a plan view from a direction orthogonal to the surface 101a of the base part, the total area of the second recessed parts 103 provided on the inner wall surface 102a of the first recessed part per one first recessed part is preferably 21% or more and 79% or less of the area of the first recessed part 102 per one first recessed part 102.

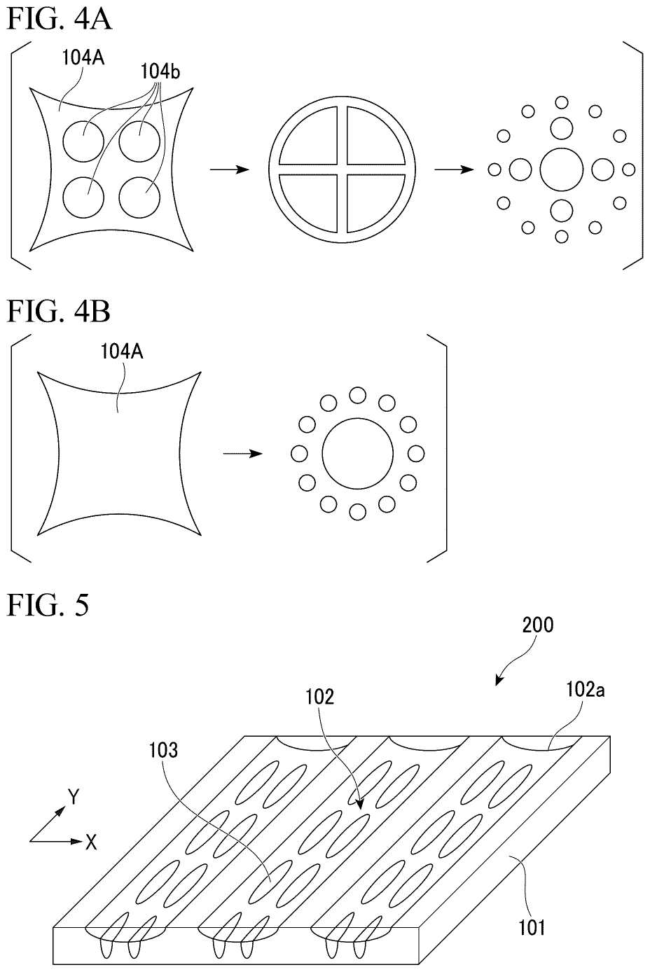

FIG. 4A is a plan view describing a mechanism in which the liquid droplet 104 is atomized in the first recessed part 102 in which the second recessed part 103 is provided. In FIG. 2A, FIG. 2B, FIG. 3A, and FIG. 3B, the process of the atomization of the liquid droplet as viewed from the cross-sectional direction has been described. Here, each state of the process of the atomization of the liquid droplet is schematically shown in order from the left side in the plan view.

Due to the rapid expansion of the second air bubble B₂ in the second recessed part 103, the released thermal energy is transferred to a plurality of positions of the liquid droplet 104, and the liquid droplet 104 becomes a thin liquid film 104A and then jets up (floats) from the structural body 100. Since the thermal energy is strongly transferred, particularly to a portion where the air bubble B₂ that has rapidly expanded is directly hit, that is, a portion directly above the second recessed part 103, the portion is relatively thin and becomes the rupture 104b. In a case where four second recessed parts 103 are formed in the first recessed part 102, as shown on the left side of FIG. 4A, ruptures 104b are formed at four positions of the liquid film 104A located directly above the four second recessed parts 103.

Subsequently, as shown in the center of FIG. 4A, the surface tension of the liquid film 104A acts on each portion around the hole, the hole is enlarged, and each portion around the hole becomes linear. Then, as shown on the right side of FIG. 4A, each of the linear portions is deformed in a beaded shape due to the explosion energy of the second air bubble B₂, and then the linear portions are separated from each other to be atomized. Since the plurality of second recessed parts 103 are provided in the first recessed part 102, the atomization can be allowed to simultaneously occur at a plurality of positions of the liquid droplet 104. In addition, in a case where the disposition of the second recessed parts 103 in the first recessed part 102 is uniform, the disposition of the holes of the liquid film 104A overlapping the second recessed parts is also uniform, and the liquid droplet 104 can be separated into a uniform size and atomized. Further, as the number of second recessed parts 103 increases, more holes are formed in the liquid film 104A, and the interval between the holes becomes narrower. Therefore, the liquid film 104A can be finely separated and atomized.

FIG. 4B shows a mechanism in which the liquid droplet 104 is atomized in the first recessed part 102 in which the second recessed part 103 is not provided. Each state of the process of the atomization of the liquid droplet is schematically shown in order from the left side.

In a case where the second recessed part 103 is not present, as in the case of FIG. 4A, no holes are formed in the liquid film 104A in association with the generation of the second air bubble B₂, and thus the central part of the liquid film 104A is not atomized. It is noted that even in this case, since the liquid droplet 104 enters the first recessed part while entangling the air present in the first recessed part, a portion where surface tension acts strongly undergoes atomization in the outer peripheral portion of the liquid film 104A since air bubbles that can be exploded are generated although the number of air bubbles generated is not as large as the number of the second air bubbles B₂.

In order to increase the rate of atomization, the base part, the optimal hole diameter (opening diameter), optimal depth, and the optimal number of the first recessed parts, and the hole diameter, depth, and the number of the second recessed parts can be determined using the average particle diameter of the liquid droplet, the Weber number We, and the temperature of the installation location for the structural body. The Weber number We is a dimensionless number consisting of a ratio of an inertial force to a surface tension, and is represented by Expression (1) using a particle diameter L, a velocity V, a density ρ, and a surface tension σ of the liquid droplet 104.

$$\begin{matrix}[ Expression 1 ] & \\ We = \frac{{LV}^{2} ρ}{σ} & ( 1 )\end{matrix}$$

From the video of the liquid droplet, the velocity and the particle diameter of the liquid droplet are analyzed using Particle Image Velocimetry (PIV) and image particle diameter analysis software, and the analysis results thereof are substituted into Expression (1), thereby being capable of calculating the Weber number required for the atomization of each liquid.

In an unprocessed material at a temperature higher than 200° C., a liquid droplet having a low Weber number does not undergo atomization and rebounds due to the influence of the vapor film caused by the Leidenfrost phenomenon; however, in a case of a liquid droplet having a sufficiently high Weber number, the liquid droplet rebounds while undergoing atomization (rebounds with break up).

On the other hand, in a structural body which has a temperature higher than 200° C. and in which the first recessed part is provided, even in a case of a liquid droplet having a low Weber number, the liquid droplet rebounds while undergoing atomization due to the effect of suppressing the generation of the vapor film, and in a case of a liquid droplet having a high Weber number, the liquid droplet undergoes atomization (breaks up) without rebounding.

In an unprocessed material at about 200° C., the heat insulation in the vapor film is less likely to occur due to deviation from the main temperature range in which the Leidenfrost phenomenon occurs; however, the liquid droplet that has collided is in a state of having a strong surface tension. Therefore, in a case where the Weber number of the liquid droplet is low, the liquid droplet that has collided undergoes desorption after adhesion without undergoing atomization; however, in a case where the Weber number of the liquid droplet is high, the liquid droplet undergoes desorption while undergoing atomization after adhesion (desorption with break up after adhesion).

On the other hand, in a structural body which has a temperature of about 200° C. and in which the first recessed part is provided, the contact angle of the liquid droplet is low on the surface on which the liquid collides, as compared with a case of the unprocessed material, the surface is likely to be hydrophilic, and the liquid droplet is spread. Therefore, a behavior of vaporization after spreading, a behavior of vaporization while undergoing desorption and atomization after spreading (desorption with break up and vaporization after spreading), or a behavior of vaporization while undergoing atomization after spreading (break up and vaporization after spreading) are mixedly present.

In an unprocessed material at about 150° C., the region is such that vaporization after adhesion of the liquid droplet is dominant, and in association with the increase in the Weber number of the liquid droplet, the behavior of the liquid droplet changes from a behavior of vaporization after adhesion to a behavior of vaporization while undergoing desorption and atomization after adhesion (desorption with break up and vaporization after adhesion).

On the other hand, in a structural body which has a temperature of about 150° C. and in which the first recessed part is provided, the behavior of the liquid droplet changes to a behavior of vaporization after spreading and a behavior of vaporization while undergoing desorption and atomization after spreading, in association with the increase in the Weber number of the liquid droplet.

The means for providing the first recessed part 102 and the second recessed part 103 is not particularly limited, and for example, laser processing can be used. That is, the first recessed part 102 can be formed by irradiating a region of the surface 101a of the base part with a laser, where the liquid droplet 104 collides, and removing a portion that is to serve as the first recessed part 102. Subsequently, the second recessed part 103 can be formed by irradiating a predetermined region of the inner wall surface 102a of the formed first recessed part with a laser and removing a portion that is to serve as the second recessed part 103.

As described above, the structural body 100 according to the present embodiment has the first recessed part 102 on the surface 101a of the base part, and further has the second recessed part 103 on the inner wall surface 102a of the first recessed part. The first recessed part 102 has a size such that the liquid droplet 104 cannot deeply enter the first recessed part 102. Therefore, in a case where the liquid droplet 104 has collided, a void is formed between the inner wall surface 102a of the first recessed part and the liquid droplet 104, and the air bubble B compressed at a high density is generated in the second recessed part 103. The air bubble B instantaneously expands and directly hits the central part of the liquid droplet 104 located at the expansion destination, thereby applying thermal energy (explosion energy) at a level exceeding the surface tension of the liquid droplet 104 to the central part of the liquid droplet 104, and the liquid droplet 104 can be subjected to fine separation to undergo atomization.

As a result, in the structural body 100 according to the present embodiment, the central part of the liquid droplet 104 after the collision remains in a coarse liquid droplet state without being separated, which makes it possible to avoid the problem that the liquid droplet 104 is not vaporized. In addition, in the structural body 100 according to the present embodiment, the inner wall surface 103a of the second recessed part is added to the first recessed part 102, and thus the area of the portion in the first recessed part 102, where the liquid droplet 104 is close, is increased. Therefore, the heat of the structural body 100 can be efficiently transferred to the liquid droplet 104 or the air bubbles in the inside of the liquid droplet 104, and a high rate of atomization of the liquid 104 that has collided can be maintained even in a case where the temperature of the structural body 100 is low.

Since the structural body 100 according to the present embodiment improves only the configuration of the liquid droplet 104 on the receiver side without changing the complicated configuration of the injection portion of the liquid droplet 104, it is possible to realize the atomization of liquid droplets with low energy consumption without using a large-scale system configuration.

### Second Embodiment

FIG. 5 is a perspective view of a structural body 200 according to a second embodiment of the present invention. In the structural body 200, in a case of being seen in a plan view from a direction perpendicular to the surface 101a of the base part, a plurality of first recessed parts 102 extending in one direction (Y direction) are provided to be arranged in a direction (X direction) intersecting (orthogonal to) the one direction. Further, the second recessed part 103 is provided on at least one inner wall surface 102a of the first recessed part. Here, a case where the second recessed part 103 extends along the extension direction of the first recessed part 102 is shown as an exemplary example in a case of being seen in the same plan view; however, the second recessed part 103 may not extend as in the first embodiment. The shape of the second recessed part 103 is not limited; however, the area and volume of the opening surface are assumed to satisfy the same conditions as those in the first embodiment. The configurations other than the first recessed part 102 and the second recessed part 103 are the same as those of the structural body 100 according to the first embodiment, and the positions corresponding to the structural body 100 are indicated by the same reference numerals regardless of the difference in shape. The same effect as the structural body 100 according to the first embodiment can also be obtained in the structural body 200.

### Third Embodiment

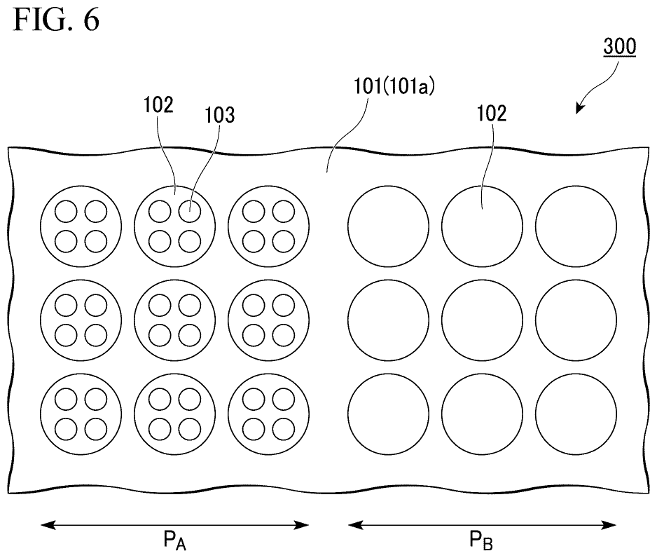

FIG. 6 is a plan view of a structural body 300 according to a third embodiment of the present invention. The positions corresponding to the structural body 100 are indicated by the same reference numerals regardless of the difference in shape. In the structural body 300, the base part 101 has a first portion P_{A} capable of having a temperature lower than the Leidenfrost phenomenon temperature and a second portion P_{B} capable of having a temperature equal to or higher than the Leidenfrost phenomenon temperature. In the first portion P_{A}, the first recessed part 102 is provided on the surface 101a of the base part, and the second recessed part 103 is provided on an inner wall surface 102a of the first recessed part 102. In the second portion P_{B}, the first recessed part 102 is provided on the surface 101a of the base part, and the second recessed part 103 is not provided on an inner wall surface 102a of the first recessed part 102.

It is noted that the configuration of the structural body 300 including the first recessed part 102 and the second recessed part 103 may be replaced with the configuration of the third embodiment including the first protruding part 105 and the second protruding part 106. That is, a configuration, in which a plurality of first protruding parts 105 are provided on the surface 101a of the base part in the first portion P_{A}, and a second protruding part 106 is provided between at least one pair of adjacent first protruding parts 105, and in addition, a plurality of first protruding parts 105 are provided on the surface 101a of the base part in the second portion P_{B}, and a second protruding part is not provided between at least one pair of adjacent first protruding parts 105, may be adopted.

The present embodiment can be applied to, for example, a situation in which a low temperature part having a temperature lower than the Leidenfrost phenomenon temperature and a high temperature part having a temperature equal to or higher than the Leidenfrost phenomenon temperature are mixedly present. That is, by installing or forming the structural body 300 configured such that the portion in contact with the low temperature part serves as the first portion P_{A} and the portion in contact with the high temperature part serves as the second portion P_{B}, on such an object, the liquid droplets that have collided with either the low temperature part or the high temperature part can also be atomized. In addition, in a case of a situation where a low temperature part having a temperature lower than the Leidenfrost phenomenon temperature and a high temperature part having a temperature equal to or higher than the Leidenfrost phenomenon temperature change with an elapse of time, the jetting port of the liquid droplet or the structural body 300 may be switched to be jetted to an appropriate portion by sliding. The atomization in the low temperature part is realized by the above-described mechanism. The atomization in the high temperature part is realized by a mechanism described in the patent document (Japanese Unexamined Patent Application, First Publication No. 2021-133321) or the like.

### Application Field of Present Invention

The liquid droplet atomization system using the structural bodies 100, 200, and 300 according to the above-described embodiment can be utilized as (1) an exhaust gas purification system, (2) a microfabrication system for a painted surface, and (3) a liquid droplet spraying system for cooling. The microfabrication system for a painted surface can be utilized particularly in an industry in which a material surface is subjected to microfabrication in order to hold a lubricating agent or cool a high-temperature wall surface by allowing the high-temperature wall surface to collide with fine liquid droplets (a semiconductor device, die casting (for an aluminum alloy, a magnesium alloy, or the like, where the metal is not particularly limited as long as it can be subjected to die casting), an industry dealing with bearings, seals, or the like). In addition, the microfabrication system for the painted surface can also be utilized for automobile body painting. The liquid droplet spraying system for cooling can be applied to a liquid droplet atomization system such as a cooling device for a nuclear power plant (a liquid droplet spraying system for reactor cooling). In addition, since the liquid droplet atomization technology can be used in a temperature range before the Leidenfrost phenomenon occurs, examples of the field in which the liquid droplet atomization technology can be used include fields such as chemistry, medicine, pharmaceuticals, and cosmetics, and also include a field for increasing the surface area of a CO₂ absorption liquid in a CO₂ absorption system.

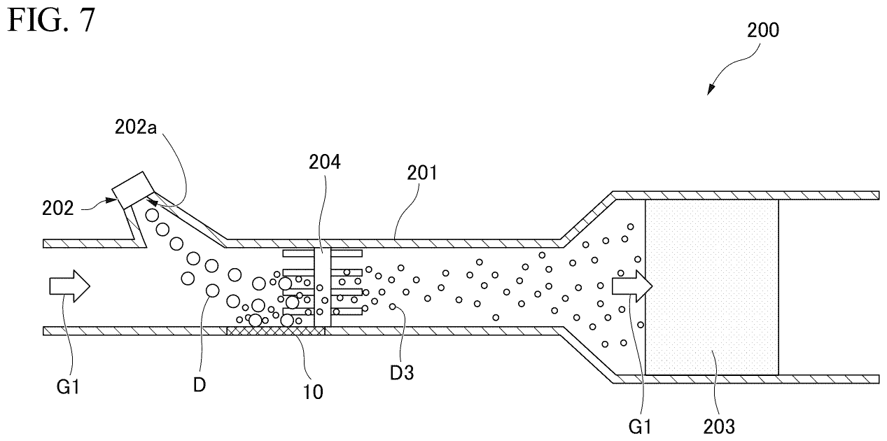

Here, as a reference, an example in which the liquid droplet atomization system is applied to an exhaust gas purification system will be described. FIG. 7 is a cross-sectional view of an exhaust gas purification system 200 including any one of the above-described structural bodies 100, 200, and 300. The exhaust gas purification system 200 mainly includes an exhaust pipe 201, an injector 202, and a catalyst accommodation part 203.

The injector 202 injects the liquid droplet D into the inside of the exhaust pipe 201 from the opening portion 201a provided in the side wall of the exhaust pipe 201. The liquid droplet D is made of a reducing material that reduces a harmful substance in the exhaust gas G1 that flows inside the exhaust pipe 201.

The exhaust pipe 201 includes the structural body 10 in at least a part of the inner wall. The structural body 10 is provided on the inner wall of the exhaust pipe 201 such that at least the side on which an uneven structure 101 is provided is in contact with the inner space of the exhaust pipe 201 at a position (a position facing the liquid droplet jetting part 202a of the injector) where the liquid droplet D to be injected collides. The structural body 10 may be integrated with the inner wall of the exhaust pipe 201 or may be separated from the inner wall of the exhaust pipe 201. A plurality of the structural bodies 10 may be provided, and the structural bodies 10 may be close to each other or may be separated from each other. Due to the above-described mechanism, the liquid droplet D that has collided with the uneven structure 101 of the structural body 10 is atomized and then flows toward the catalyst accommodation part 203 together with the exhaust gas G1.

The catalyst accommodation part 203 is disposed on the downstream side of the exhaust gas G1 in the exhaust pipe 201 with respect to the position where the liquid droplet D is injected, and accommodates a catalyst that promotes a reaction between a harmful substance in the exhaust gas G1 and NH₃ generated from the atomized liquid droplet D3. The NH₃ generated from the harmful substance in the exhaust gas G1 and the atomized liquid droplet D3 undergoes a reaction through the catalyst and is converted (purified) into a harmless substance.

A mixer 204 that makes the flow of the exhaust gas G1 and the liquid droplets D3 uniform between the structural body 100 and the catalyst accommodation part 203 may be provided in the exhaust pipe 201. The structural body 10 may be provided in the mixer 204, and the mixer 204 in this case has the uneven structure 101 at a branch portion or the like at a position (a position facing the liquid droplet jetting part of the injector) where the liquid droplet D to be injected collides.

According to the exhaust gas purification system 200 described above, for example, in a case where the harmful substance in the exhaust gas G1 flowing in the exhaust pipe 201 is NOₓ, by injecting the liquid droplet D of urea water into the exhaust pipe 201, the NH₃ generated from the atomized liquid droplet D3 can react with NOₓ through the catalyst to convert NOₓ into N₂ and H₂O, which are harmless substances.

### EXAMPLES

Hereinafter, the effects of the present invention will be described in greater detail with reference to Examples. It is noted that the present invention is not limited to the following Examples, and can be appropriately modified and implemented within the scope which is not departing from the gist of the present invention.

### Example 1

The structural body according to the first embodiment was prepared. The base part of the structural body was heated to 270° C., and liquid droplets of purified water were allowed to collide with the surface of the base part on which the first recessed part and the second recessed part were provided.

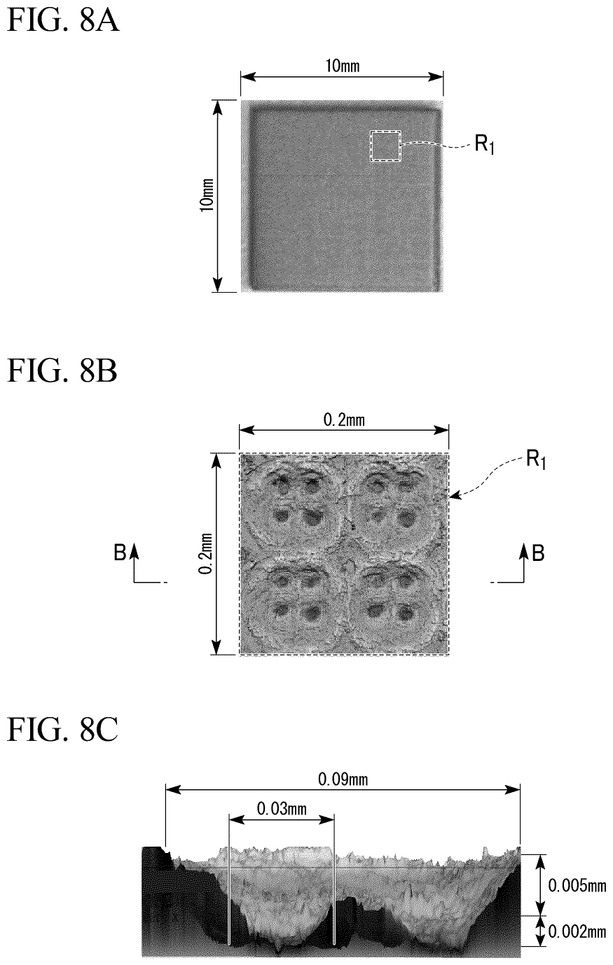

FIG. 8A, FIG. 8B, and FIG. 8C are photomicrographic images of the prepared structural body. FIG. 8A is a photographic image of the entire structural body on the surface side thereof, which is allowed to collide with the liquid droplet. FIG. 8B is a photomicrographic image obtained by enlarging a part (a region having an area of 0.04 mm² (=0.2 mm×0.2 mm)) on the surface side of FIG. 8A. FIG. 8C is a photomicrographic image of a cross section in a case where the first recessed part included in the enlarged the surface side of FIG. 8B is cut along a plane including the line B-B.

For the structural body (base part), the area of the surface was set to 100 mm² (=10 mm×10 mm), and the thickness of the structural body in a direction orthogonal to the surface was set to 1.0 mm. The first recessed parts were formed at a ratio of one per area of 0.04 mm² on the surface. The particle diameter of the liquid droplet was set to 60 to 70 μm, the hole diameter on the opening surface of each first recessed part was set to 0.09 mm, and the depth was set to 0.005 mm. Four second recessed parts were formed in one first recessed part. For each second recessed part, the hole diameter on the opening surface was set to 0.03 mm, and the depth was set to 0.002 mm.

### Example 2

A structural body having the same configuration as that of Example 1 was prepared, the structural body was heated to 200° C., and liquid droplets of purified water were allowed to collide with the surface of the base part on which the first recessed part and the second recessed part were provided.

### Example 3

A structural body having the same configuration as that of Example 1 was prepared, the structural body was heated to 150° C., and liquid droplets of purified water were allowed to collide with the surface of the base part on which the first recessed part and the second recessed part were provided.

### Comparative Example 1

A structural body (unprocessed member) in which the first recessed part and the second recessed part were not provided on the surface of the base part was prepared, the structural body was heated to 270° C., and liquid droplets of purified water were allowed to collide with the surface.

### Comparative Example 2

A structural body (unprocessed member) in which the first recessed part and the second recessed part were not provided on the surface of the base part was prepared, the structural body was heated to 150° C., and liquid droplets of purified water were allowed to collide with the surface.

### Comparative Example 3

A structural body in which a first recessed part was provided on the surface of a base part and a second recessed part was not provided on an inner wall surface of the first recessed part was prepared, the structural body was heated to 270° C., and liquid droplets of purified water were allowed to collide with the surface of the base part.

### Comparative Example 4

A structural body in which a first recessed part was provided on the surface of a base part and a second recessed part was not provided on an inner wall surface of the first recessed part was prepared, the structural body was heated to 200° C., and liquid droplets of purified water were allowed to collide with the surface of the base part.

### Comparative Example 5

A structural body in which a first recessed part was provided on the surface of a base part and a second recessed part was not provided on an inner wall surface of the first recessed part was prepared, the structural body was heated to 150° C., and liquid droplets of purified water were allowed to collide with the surface of the base part.

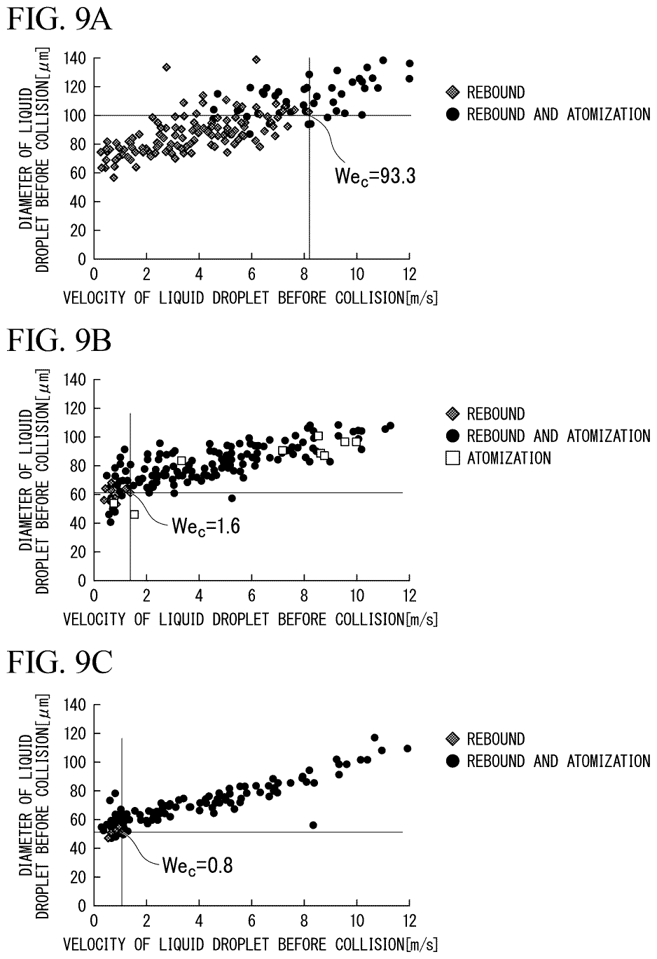

For each of the structural bodies of Comparative Examples 1 and 2 and Example 1, the velocity and the particle diameter of the liquid droplet were analyzed from the image of the liquid droplet before the collision, and the relationship therebetween was examined. Each of FIG. 9A, FIG. 9B, and FIG. 9C is a graph showing the conditions under which the liquid droplets to collide with each of the structural bodies of Comparative Examples 1 and 2 and Example 1 undergo atomization. The horizontal axis of the graph indicates the velocity [m/s] of the liquid droplet before the collision, and the vertical axis of the graph indicates the particle diameter [μm] of the liquid droplet before the collision.

A plot, in which the Weber number of the liquid droplet that did not undergo atomization after the collision had the maximum value was defined as the critical Weber number, evaluated as an index of the effect of promoting atomization by the microfabrication. In a case where the liquid droplets were separated into particles having an average particle diameter of 20 μm or less, it was determined that the liquid droplets had undergone atomization. From the graph of FIG. 9A, it can be seen that the critical Weber number is as high as 93.3 in the structural body of Comparative Example 1. On the other hand, it can be seen from FIG. 9B that, in the structural body in which the first recessed part is provided on the surface of the base part of the structural body, the atomization can be carried out even in a case where the critical Weber number is reduced to 1.6. Then, it can be seen from FIG. 9C that, in the structural body in which the second recessed part is provided on the inner wall surface of the first recessed part, the atomization can be carried out even in a case where the critical Weber number is further reduced to 0.8.

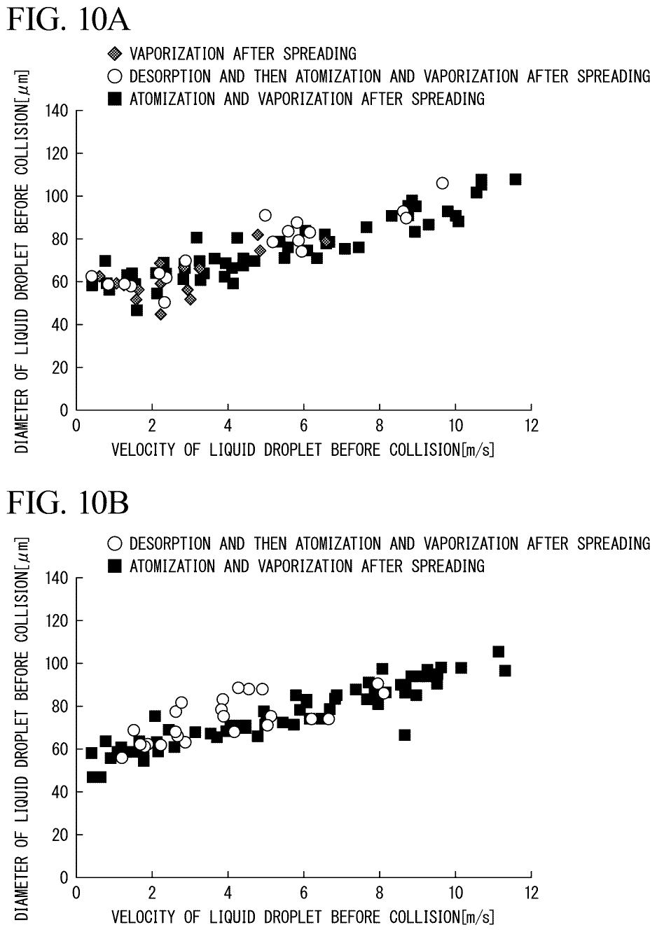

For each of the structural bodies of Comparative Example 4 and Example 2, the velocity and the particle diameter of the liquid droplet were analyzed from the image of the liquid droplet before the collision, and the relationship therebetween was examined. Each of FIG. 10A and FIG. 10B is a graph showing the conditions under which the liquid droplets to collide with each of the structural bodies of Comparative Example 4 and Example 2 undergo atomization. The horizontal axis and the vertical axis of the graph are the same as those of FIG. 9A, FIG. 9B, and FIG. 9C.

From the comparison between the graphs of FIG. 10A and FIG. 10B, there is no difference regarding whether the structural body of Comparative Example 4 and the structural body of Example 2 undergo atomization after the liquid droplets collide and then spread or undergo vaporization without undergoing atomization.

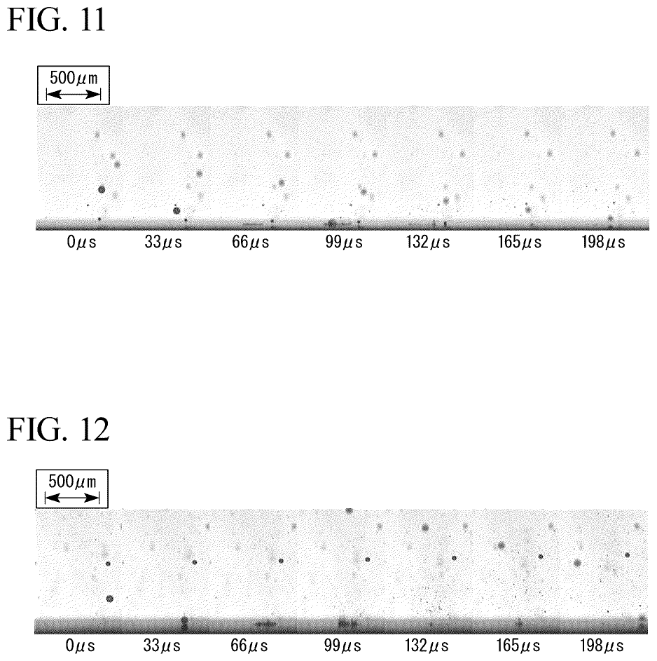

Each of FIG. 11 and FIG. 12 is an image obtained by imaging the behavior of a liquid droplet collided with the surface of each of the structural bodies of Comparative Example 4 and Example 2, in which the time of the collision is set to 99 μs and the images before and after the collision are arranged for each elapsed time. The liquid droplet of Comparative Example 4 spreads after the collision with the structural body (after 99 μs) and thus is not atomized, whereas the liquid droplet of Example 2 uniformly undergoes atomization after the collision with the structural body.

In the structural body of Example 2, it is considered that air bubbles are generated in the second recessed part in association with the collision of the liquid droplet, and the thermal energy due to the rapid expansion of the air bubbles is transferred to the entire liquid droplet, and as a result, the liquid droplet is finely and uniformly separated and atomized. On the other hand, in the structural body of Comparative Example 4, it is considered that there is no second recessed part that generates air bubbles, the thermal energy is not sufficiently transferred to the central part of the liquid droplet and as a result, the central part of the liquid droplet is not separated and remains as a coarse liquid droplet, and thus the liquid droplet is not vaporized in a short time and spreads on the surface of the structural body as a liquid. From these results, it can be seen that, in the low temperature region where the wall surface temperature is 200° C. or lower, the structural body in which both the first recessed part and the second recessed part are provided is effective.

In the structural body at a temperature of about 150° C., the behavior of the liquid droplet after the collision is mainly a behavior of vaporization after adhesion. Therefore, the time taken for the liquid droplet to vaporize after the adhesion to the wall surface was checked for each particle diameter of the liquid droplet before the collision in the structural body (the present invention) in which the second recessed part was provided on the inner wall surface of the first recessed part and the structural body in which the second recessed part was not provided on the inner wall surface of the first recessed part.

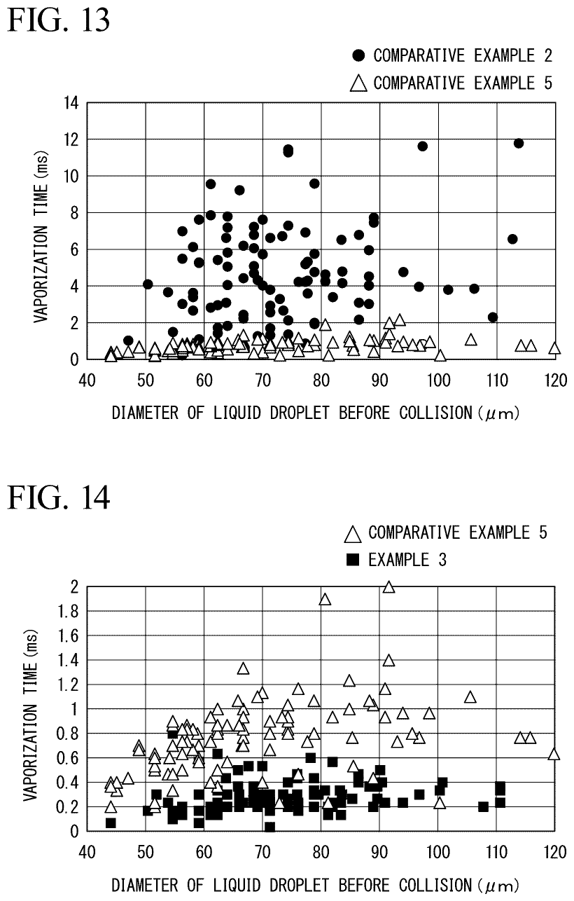

FIG. 13 is a graph showing a relationship between the particle diameter of the liquid droplet and the vaporization time of the liquid droplet before the collision in a case where the structural bodies of Comparative Examples 2 and 5 and Example 3 are used. FIG. 14 is a graph in which the range of the vaporization time of 2 μm or less in the graph of FIG. 13 is enlarged. The horizontal axis of the graph indicates the particle diameter (μm) of the liquid droplet before the collision, and the vertical axis of the graph indicates the vaporization time (ms). A time at which the liquid droplet adheres to the wall surface is set to 0 μs, and a time taken until the moment at which the brightness value indicating the liquid droplet disappears from the visualization image is defined as a vaporization time.

From FIG. 13, it can be seen that, in a case where the structural body (unprocessed material) of Comparative Example 2 is used, the vaporization time of the liquid droplet is 2 to 12 ms, whereas in a case where each of the structural bodies of Example 3 and Comparative Example 5 having the first recessed part is used, the vaporization time is shortened to 2 ms or less. It is considered that the reason why the vaporization time of the liquid droplet is shortened in Example 3 is that the hydrophilicity is exhibited by the dimple shape in which the static contact angle is decreased, and the vaporization of the liquid droplet is promoted by increasing the contact area between the liquid droplet and the wall surface.

From FIG. 14, it can be seen that in a case where the structural body of Example 3 is used, the vaporization time of the liquid droplet is shortened to 0.8 ms or less due to an increase in the contact area for the portion where the second recessed part is provided. From these results, it can be seen that the first recessed part and the second recessed part provided in the structural body according to the present invention are extremely effective from the viewpoint of promoting vaporization from the urea water in the lowest temperature range in a case where the urea SCR system is used.

### INDUSTRIAL APPLICABILITY

The structural body of the present invention can promote the atomization and vaporization of urea water by applying the structural body to a mixer for a urea SCR system of an exhaust gas purification device and a wall surface of an exhaust pipe.

In addition, it is considered that the structural body according to the present invention can also be applied to the following applications that require a technological method for the atomization of the collision liquid droplets and the adjustment of the particle diameter of the collision liquid droplets.
(1) An industry (semiconductor devices, aluminum die casting, bearings, seals, and the like) in which a material surface is subjected to microfabrication in order to hold a lubricating agent or cool a high-temperature wall surface by allowing the high-temperature wall surface to collide with fine liquid droplets
(2) Automobile body painting (microfabrication on a painted surface)
(3) Cooling device for nuclear power plant (liquid droplet spraying system for reactor cooling)
(4) CO₂ absorption system (for increasing surface area of CO₂ absorption liquid)

### REFERENCE SIGNS LIST

100, 200, 300 Structural body
101 Base part
101a Surface of base part
102 First recessed part
102a Inner wall surface of first recessed part
102b Opening surface of first recessed part
102c Hole diameter of opening surface of first recessed part
103 Second recessed part
103a Inner wall surface of second recessed part
104 Liquid droplet
104a Particle diameter of liquid droplet
104A Liquid film
104b Rupture of liquid film
105 First protruding part
105a Distance between first protruding parts
106 Second protruding part
200 Exhaust gas purification system
201 Exhaust pipe
202 Injector
202a Liquid droplet jetting part
203 Catalyst accommodation part
204 Mixer
B Air bubble
B₁ First air bubble
B₂ Second air bubble
P_{A} First portion
P_{B} Second portion
R Region

1. A structural body which is allowed to collide with a liquid droplet, the structural body comprising:
a base part that has a temperature equal to or higher than a vaporization temperature of the liquid droplet;
one or more first recessed parts provided on a surface of the base part; and
a plurality of second recessed parts provided on an inner wall surface of at least one of the first recessed parts.

2. The structural body according to claim 1,
wherein a hole diameter of the first recessed part is larger than a particle diameter of the liquid droplet before the collision,
a hole diameter of the second recessed part is smaller than the particle diameter of the liquid droplet before the collision,
a total of a volume of the first recessed part and a volume of the second recessed part is larger than a volume of the liquid droplet before the collision, and
at least a part of a space in the first recessed part is filled with the liquid droplet after the collision.

3. The structural body according to claim 1,
wherein the temperature equal to or higher than the vaporization temperature is a first temperature at which a vaporization phenomenon or a boiling phenomenon of the liquid droplet occurs and which is lower than a temperature at which a Leidenfrost phenomenon occurs.

4. The structural body according to claim 1,
wherein the temperature equal to or higher than the vaporization temperature is a second temperature at which a vaporization phenomenon, a boiling phenomenon, and a Leidenfrost phenomenon of the liquid droplet occur in a mixed manner.

5. A design method for the structural body according to claim 1, the design method comprising:
determining a configuration of the first recessed part and the second recessed part such that, in a state in which the liquid droplet collides with the structural body and enters the first recessed part and the second recessed part, a surface tension at the temperature equal to or higher than the vaporization temperature of the liquid droplet is smaller than an explosion energy of air bubbles generated in the liquid droplet, and the air bubbles include
a first air bubble generated by a heat flux transferred from an inner wall surface of the first recessed part and an inner wall surface of the second recessed part to the liquid droplet in contact with the first recessed part and the second recessed part, and
a second air bubble generated in a case where air trapped between the collided liquid droplet and the inner wall surface of the second recessed part is incorporated into the liquid droplet.

6. A design method for the structural body according to claim 1, the design method comprising:
determining the base part, hole diameters, depths, and the number of the first recessed parts, and hole diameters, depths, and the number of the second recessed parts based on an average particle diameter and a Weber number of the liquid droplets and a temperature of an installation location for the structural body.

7. A liquid droplet atomization system comprising:
the structural body according to claim 1.
